(19) United States
(12) Patent Application Publication
(10) Pub. No.: US 2005/0108414 A1
(43) Pub. Date: May 19, 2005

(54) System and method for transmitting data in computer systems using virtual streaming

(76) Inventors: Thomas M. Taylor, Kelowna (CA); Robert Arn, Kelowna (CA); Justin S. McMichael, Kelowna (CA)

Correspondence Address: Clifford W. Vermette;Vermette & Co., Box 40, Granville Square, 200 Granville Street, Suite 230, Vancouver, BC, V6C 1S4, CA

(21) Appl. No.: 10/986,861

(22) Filed: Nov. 15, 2004

Related U.S. Application Data
(60) Provisional application No. 60/519,644, filed on Nov. 14, 2003.

(51) Int. Cl. G06F 15/16

(52) U.S. Cl. 709/231

(57) ABSTRACT

A system and method for transmitting data in computer systems using virtual streaming is described. Virtual streams are created by separation of the data into a plurality of parts which are stored on various components of the system and transmitted through multiple channels as partial streams, each representing a part of an overall virtual stream. The multiple partial streams are adapted to the characteristics of multiple channels allowing flexibility in optimizing the system for data link bandwidth requirements, user choice of specific desired contents, immediacy of media delivery, and security. The multiple partial streams comprising a single virtual stream are re-combined at the destination for presentation or subsequent processing.

### FIELD OF THE INVENTION

This invention pertains to transmission of data within a computer system, either locally, within a single computer, or between multiple computers in a network. More specifically, it describes a method of spreading data among multiple channels so that data transmission may be rapid without incurring unacceptable costs of increasing the bandwidth of specific links in the system (such as the data link to a primary data-streaming server or the data link to a specific storage device). Further, it pertains to maintaining the security of the media transmitted within such a local or networked system.

### BACKGROUND OF THE INVENTION

For any computer system in which the size of data to be processed exceeds the size of random access memory available, the necessity exists of moving the data required for immediate processing from some storage device to the random access memory which is immediately accessible to the CPU. Such storage devices can be diverse, including magnetic storage of many types, such as hard disk drives, floppy disk drives, tape drives with many technical variations, optical storage of many types, such as Compact Disks, DVDs, optical tape drives and many technical variants such as three dimensional or holographic optical stores, and many variants of semiconductor-based storage. The physical storage devices may be locally connected via cables or bus connectors, or may be remotely connected via a network.

Typical computer systems now incorporate a variety of such storage devices, usually one or more magnetic hard disk drives, one or more CD and/or DVD optical drives, a network connection for remote data access and often provision for a removable semi-conductor storage device such as Compact Flash card.

Most efforts to improve the performance of the transmission of data from storage systems to execution RAM have concentrated on a single homogeneous storage medium. For instance, Redundant Arrays of Inexpensive Disk (RAID) systems have been created to increase the transfer rate from magnetic hard disk drives and it is conceivable that the same techniques could be applied to other storage media. The basic technique is often called “striping”, whereby successive quanta of a data sequence are multiplexed and written in parallel on multiple drives then read in parallel and de-multiplexed back into an identical data sequence on retrieval. The technique is not used across different storage media because of the difficulty of synchronizing multiple storage devices with different writing, reading and retrieval characteristics. Thus, there are no commonly used methods for improving the performance and efficiency of systems comprised of multiple heterogeneous storage devices. Typically, adding a storage device to a system increases the capacity of the system, but does not increase the data transmission rate.

Further, because of the difficulty of managing heterogeneous storage systems, the data of a specific application have typically been stored on a single type of storage even when multiple types are routinely available. Often this extends to transferring all of the data from one storage medium to another as in the case of transferring application data from a distribution optical medium such as CD or DVD to a magnetic hard disk drive and subsequently only using the hard disk drive to access the data.

The difficulty of managing heterogeneous storage systems is compounded by the introduction of data which is not local to the computer which is consuming the data, but may be at a remote location in a network. The growth of the Internet has begun to change the requirements for data transmission from storage devices. It is now commonplace that applications combine access to local magnetic and optical storage systems with data delivered from the network.

The problem of network data retrieval is difficult in itself, separate from the overall problem of optimizing entire systems of heterogeneous storage types, and is becoming more difficult as the types and quantities of network data traffic change. Internet data transfer began with compact media forms such as text files and small static images (which suit the file transport paradigm of the dominant Hypertext Transport Protocol). However, the Internet is increasingly used as a transport for large sound and video media and interactive gaming multi-media which are more sensitive to data retrieval limitations.

In particular, sound and video are fundamentally different from discrete file media in that they are presented continuously in time. It is possible to use a file download approach to the delivery of such media, but it is annoying to the user to have to wait until a whole file is transferred before beginning to experience the media—particularly because such media files are often very large and require long times to transmit.

In response, a number of vendors, including Real Networks and Microsoft, have commercialized technology to transmit such continuous-time dependent media as continuous streams of data which can be experienced as the data are received rather than waiting for an entire media file to be downloaded and as well to transmit to more than one user at a time with multi-casting protocols.

Within the current bandwidth constraints that are typical on the Internet, these streaming and multi-casting technologies allow the transmission of high quality audio over the Internet. As the bandwidth of the Internet increases it can be anticipated that similar transmission of video and other high capacity media will also become commercially feasible. Such capabilities today have led to the development of Internet radio stations and can be anticipated to ultimately lead to the creation of Internet television stations.

However, all current streaming and multi-casting systems continue to suffer from a set of inter-related limitations and constraints affecting scalability, selectivity and security.

Scalability continues to be a problem because most existing Internet infrastructure is still based on routing data through a number of intermediate servers from a point of origin to a single destination. Streaming in this model is extremely inefficient, requiring essentially a separate stream for each user that is serviced which quickly overloads both the streaming server and the data link capacities.

Multi-casting technologies are a response to such bottlenecks, but unfortunately current multi-casting protocols require that all the intervening servers between the origin server and the destination users be upgraded to support the multi-casting protocol. Hence multi-casting cannot be easily and transparently introduced into the existing heterogeneous Internet.

The goal of allowing maximal user selectivity of data is also at odds with multi-casting techniques. Ideally, each individual user would be free to specify the specific content and order of media that he or she would receive. However, this goal runs counter to the fundamental multi-casting approach which relies on sending the same data to multiple users at once.

Edge-caching is another measure to eliminate network and server bottlenecks that has been introduced by vendors such as Akamai to increase scalability by introducing multiple servers in different sectors of the Internet, Edge-caching does not degrade user selectivity, but unfortunately, the cost of edge-caching services can undermine the economics of media distribution systems that hope to capitalize on the Internet as a low-cost transmission system.

The most extreme form of edge-caching is found in Peer to Peer Networks (“P2P”) which organize the computing facilities of individual end users to transmit data to other end users. P2P networks are also interesting in that they may go beyond edge-caching in allowing a client to transparently request data from a plurality of servers in parallel. However, they do not address the issue of optimizing local storage systems or heterogeneous local and remote storage systems, or any application involving more than simple downloading of files where copies are stored in multiple network locations. The primary deficiencies that are found in P2P networks are unpredictable quality of service and data integrity combined with difficulty in securing the data transmitted. Today, P2P networks are primarily used in ad hoc sharing of media that contravenes or ignores the data owners' intellectual property rights.

It is evident, given the increasing diversity of local and networked computer systems and application types, that technology that allows optimization of local, remote and mixed data transmission from storage would provide substantial utility. The current invention provides a system and method of optimizing such data transmission by dividing the data into multiple partial streams which are encoded in a manner appropriate to the available channels, transmitted and recombined into a single virtual stream at the destination.

### SUMMARY OF THE INVENTION

Briefly, the invention is a system and method for transmitting data in computer systems, either a local computer system or an extended network of computers, which includes the steps of dividing the data into a plurality of parts, storing the parts on various components of the system, optionally processing or transforming each part in a fashion that matches it to the optimal characteristics of the channel or channels connected to the component, before transmitting the parts through multiple channels as partial streams, each representing a part of an overall virtual stream, then re-assembling the partial streams within a receiving computer for further processing or presenting the media to the end user. The components of the system on which the parts of the media data may be stored include network database, file and streaming servers and the subsystems of client devices such as magnetic storage devices, optical storage devices and various organizations of random access memory and read-only memory. The processing which may be optionally performed on each part of the media data may include compression, transcoding, encryption/decryption and metadata tagging, The separation of the media data into specific parts is decided on the basis of the specific type of media data, the types of storage available throughout the system, the characteristics of the transmission channels that connect the components of the system, the processing resources available in each component of the system and the optimization goals of the provider of the media data which will vary depending on the provider's priorities between scalability, user selectivity of data and security of data.

### BRIEF DESCRIPTION OF THE FIGURES

FIG. 1A is a block diagram of a local computer system used in practicing an embodiment of the invention including an overview of the paths of multiple partial data streams which are integrated into a single virtual stream.

FIG. 1B is a block diagram of a local and remote computer system used in practicing another embodiment of the invention including an overview of the paths of multiple remote partial data streams which are integrated by the local computer system.

FIG. 1C is a block diagram of a mixed local and remote computer system used in practicing another embodiment of the invention including an overview of the paths of multiple local and remote partial data streams which are integrated by the local computer system.

FIG. 1D is a block diagram of a local computer system used in practicing another embodiment of the invention showing the creation of multiple partial data streams from a single device and the re-integration of the multiple partial data streams into an integrated virtual stream.

FIG. 2A is a representation of the initialization process and data flows creating and storing multiple partial data streams which is practiced according to various embodiments of the present invention.

FIG. 2B is a representation of the retrieval and integration process and data flows of retrieving and re-integrating multiple partial data streams into a single virtual stream which is practiced according to various embodiments of the present invention.

FIG. 3A is a representation of some exemplary operations on that may be practiced on data during the initialization process which is practiced according to various embodiments of the present invention.

FIG. 3B is a representation of some exemplary operations on that may be practiced on data during the retrieval and re-integration process which is practiced according to various embodiments of the present invention.

### DETAILED DESCRIPTION OF THE PREFERRED EMBODIMENTS

A system and method of transmitting data in computer systems whereby the data are divided into two or more partial streams, processed for transmission through specific channels, transmitted and recombined at the destination so as to optimize the transmission speed, or data security, or functional utility of the data is described.

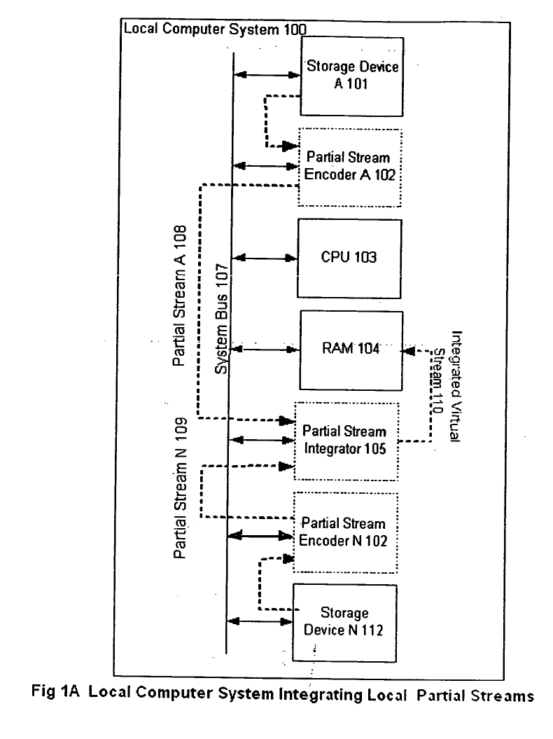

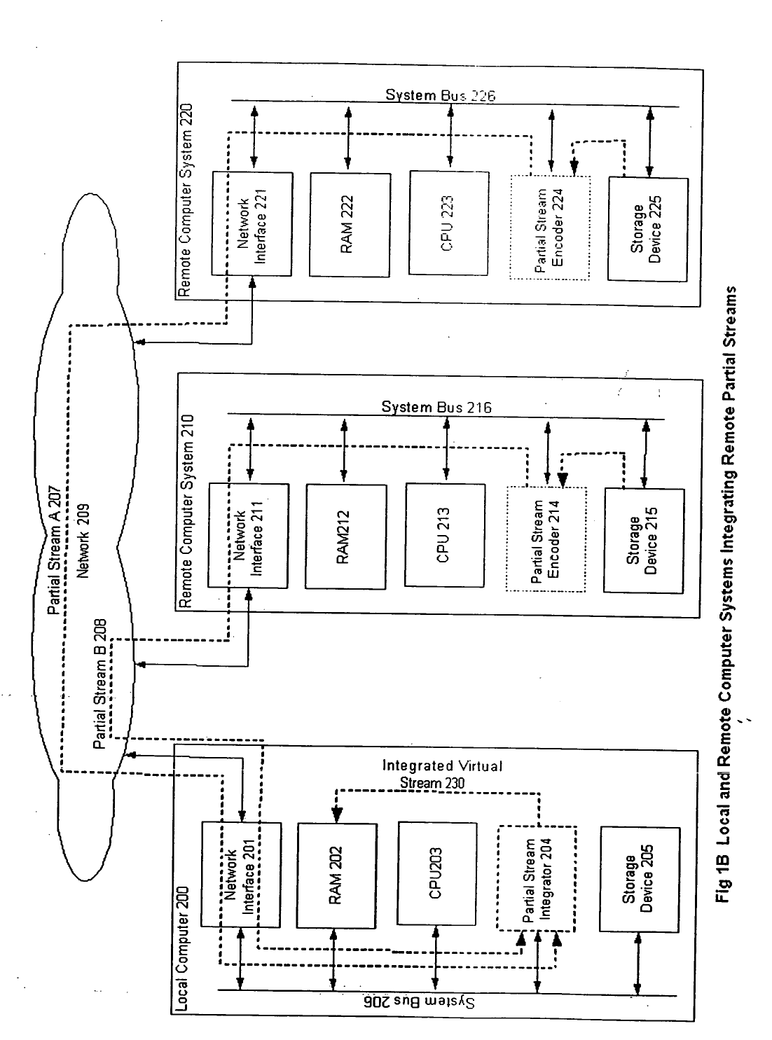

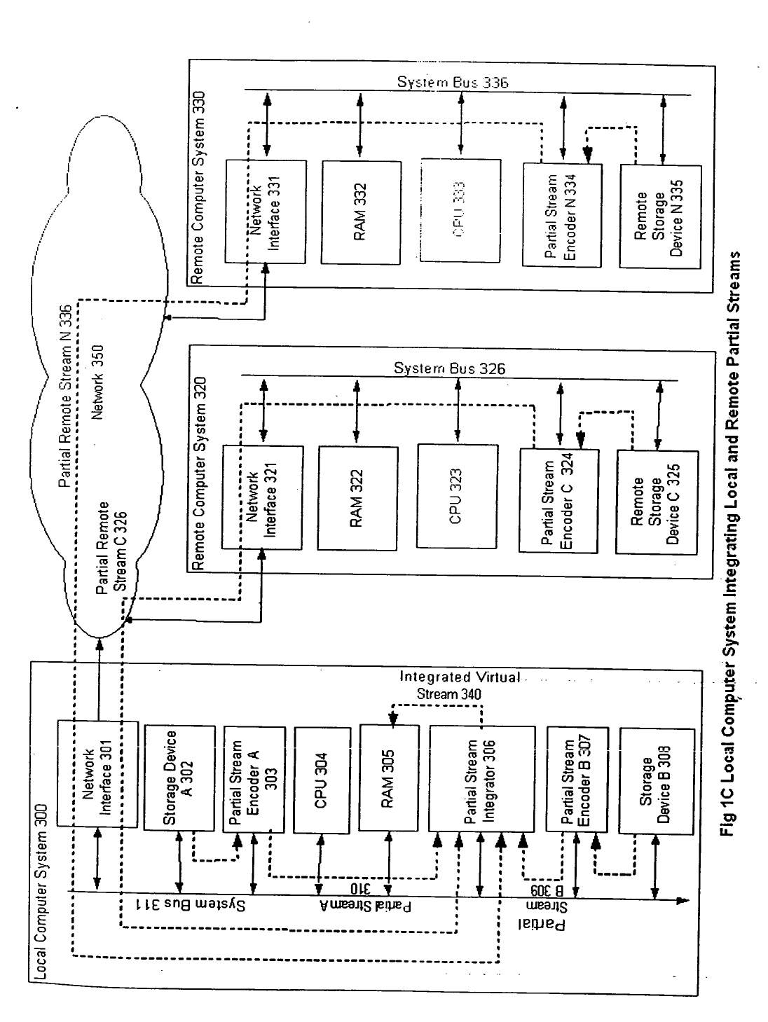

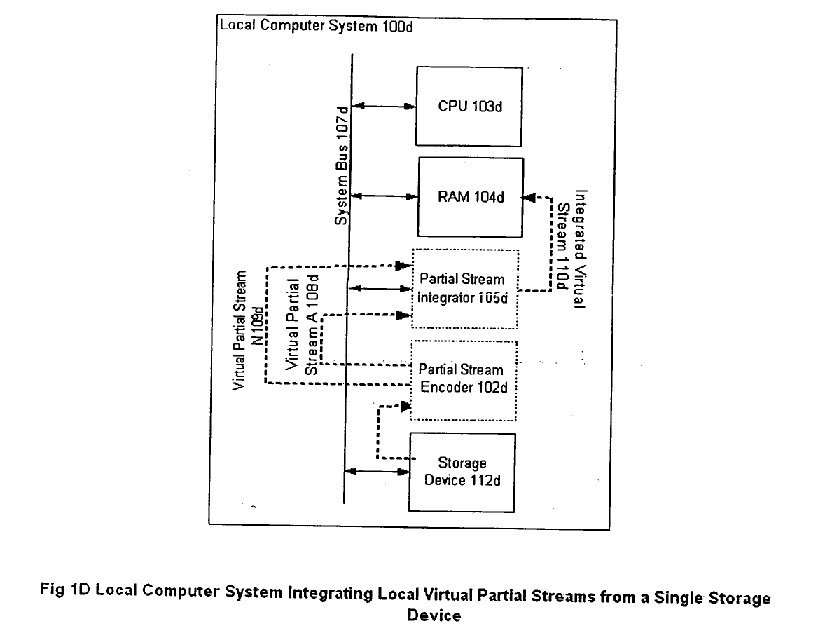

FIG. 1A shows a block diagram illustrating an example of a local computer system 100 in accordance with the present invention. The local computer system 100 includes a System Bus 101 that couples together a CPU 103, RAM memory 104, a Storage Device A 101, and another Storage Device N 106 and further shows a Partial Stream Encoder A 102, a Partial Stream Encoder N 112 and a Partial Stream Integrator 105 according to this invention, whereby a collection of associated data is stored on the Storage Device A 101 and Storage Device N 106 either separated into component parts and distributed between said storage devices, or as duplicates stored on each of said storage devices. Upon a program request for said data, Partial Stream Encoder A 102 and Partial Stream Encoder N 106 select and encode a Partial Stream A 108 and a Partial Stream N 109 of data from the respective storage device with which they are associated, said partial streams consisting of either all of the component parts stored on said associated Storage Device if the data has been divided and distributed onto the storage devices, or a pre-arranged portion of duplicate data in the case that full duplicate data is stored on each Storage Device. Partial Stream A 108 and Partial Stream N 109 are communicated to Partial Stream Integrator 105 which restores full collection of data by combining said partial streams into an Integrated Virtual Stream 110 and communicates said Integrated Virtual Stream to RAM 104 where it is available for further processing by CPU 103 or such other functional units as may be connected to the System Bus 107. Depending on the distribution of data and the encoding implemented by the Partial Stream Encoders 102 and 112 and decoded by the Partial Stream Integrator 105, the overall system can be targeted to perform a number of different optimizations and combinations thereof, including maximizing transmission bandwidth, assuring the security of data in transmission, and controlling the selectivity of programs to components of the overall virtual stream.

Overall, the description of the Local Computer System 100 structure is intended to be broadly illustrative rather than prescriptive and one skilled in the art will understand that a variety of physical and logical architectural variations are possible without changing the fundamental relationship of the local computer system to the described Partial Stream Encoders 102 and 112 and Partial Stream Integrator 105. FIG. 1A is intended to represent and it will be recognized by skilled practitioners to represent a generalized expandable computer system in which an essentially unlimited number of functional modules may be added to expand the system without altering the described invention and that the same functional arrangement could be achieved by variations in the approach to interconnecting the functional modules by other means, such as, for example a switched fabric interconnection system such as InfiniBand. In particular, FIG. 1A is intended to describe a system in which any desired number of Storage Devices with associated Partial Stream Encoders may be installed and in which the Partial Stream Integrator 5 may function to recombine any number of partial streams generated by the number of installed Storage Devices with Partial Stream Encoders. Finally, skilled practitioners will also understand that such a generalized Local Computer System is not limited in its potential functions and roles in large computer systems and may be used as a stand-alone intelligent storage device which could be coupled into another computing system either by local connection to the bus of the host system or through a network such as the Internet to a remote host system. Similarly, a skilled practitioner will understand that the entire local computer system with its associated partial stream encoder and partial stream integrator could by miniaturized to the point of inclusion in a storage device and such enhanced storage devices interconnected in arrays to provide cost-effective implementations of the described invention.

As will be appreciated by those skilled in the art, the system bus 101 may take a variety of forms and may have various combinations of private bus structures to couple added components to the local computer system. Such skilled practitioners will recognize that the functional blocks connected to said bus may be physically implemented as discrete physical units that plug into connectors on the bus or as collections of integrated circuits all on a single computer motherboard or even as a collection of circuits on a single chip or wafer. Equally, such skilled practitioners will recognize that the CPU 106 and RAM 104 in any of the levels of integration described above may be included as a standard function on the motherboard or boards of the host computer rather than being added to the expansion bus of the local computer system. As well, such skilled practitioners will understand that Storage Devices 101 and 106 may be, for example, any combination of magnetic storage of many types, such as hard disk drives, floppy disk drives, tape drives with many technical variations, optical storage of many types, such as Compact Discs, DVDs, optical tape drives and many technical variants such as three dimensional or holographic optical stores, and many variants of semiconductor-based storage or other storage means that the local computer system may implement to provide temporary or persistent storage for data and executable program code, and that said storage devices may be coupled into the Local Computer System 100 by a number of different data transfer protocols, for example, storage specific interfaces such as parallel ATA or serial ATA, ISA or RAID, or more general protocols such as such as USB and IEEE 1394, and a number of physical connection types and configurations including, for example, direct bus connections, indirect bus connections through a controller card installed on the bus, physically packaged inside the local computer system or coupled into it through cables as separately packaged external units.

The representation of the plurality of Partial Stream Encoders 102 and 112 and the Partial Stream Integrator 105 is intended to convey, and will be understood by a skilled practitioner, to indicate a logical functional unit which might typically be implemented as a software function which executes on the CPU 103 of the Local Computer System 100, but which could equally and functionally equivalently be implemented in a variety of forms, including, for example, as a special purpose co-processor board physically installed on the System Bus 107, or a program running on a separate CPU connected to the bus of the local computer system, or a custom ASIC or other integrated circuit installed on the system bus or mother board of the local computer system.

FIG. 1B shows a Local Computer System 200 communicating through a Network Interface 201 over a Network 209 with a Remote Computer System 210 through a Network Interface 211 and 220 through and a Remote Computer System 220 through a Network Interlace 221. A practitioner skilled in the art will understand that Local Computer System 200 is the same as Local Computer System 100 described in FIG. 1A and may be understood to include all the architectural and implementation variants described there with the exception that it does not include multiple Storage Devices with associated Partial Stream Encoders as there described. Instead, the local computer system 200 communicates through a Network Interface 201 through a Network 209 to a Remote Computer System 210 through its Network Interface 211 with a Partial Stream Encoder 214 which encodes a Partial Stream B 208 of data stored on Storage Device 215 and also communicates through Network Interface 201 through Network 209 to a Remote Computer System 220 through its Network Interface 221 with a Partial Stream Encoder 224 which encodes a Partial Stream A 207 of data stored on Storage Device 225. Remote Computer Systems 210 and 220 may be understood to include all of the architectural and implementation variants described for Local Computer System 100 as described in FIG. 1A, except that they do not include a Partial Stream Integrator, communicating instead with the Partial Stream Integrator 204 on Local Computer 200, in the case of Remote Computer System 210 from Partial Stream Encoder 214 through the path of Network Interface 211 through Network 209 and Network Interface 211 and in the case of Remote Computer System 220 from Partial Stream Encoder 224 through the path of Network Interface 221 through Network 209 and Network Interface 211.

In this embodiment, a collection of associated data is stored on the Storage Device A 215 and Storage Device N 225 with the data either separated into component parts and distributed between said storage devices, or as duplicates stored on each of said storage devices. Upon a program request for said data, Partial Stream Encoder A 215 and Partial Stream Encoder N 225 select and encode a Partial Stream A 208 and a Partial Stream N 207 of data from the respective storage device with which they are associated, said partial streams consisting of either all of the component parts stored on said associated Storage Device if the data has been divided and distributed onto the storage devices, or a pre-arranged portion of duplicate data in the case that full duplicate data is stored on each Storage Device. Partial Stream A 208 and Partial Stream N 207 are communicated to Partial Stream Integrator 204 which restores full collection of data by combining said partial streams into an Integrated Virtual Stream 230 and communicates said Integrated Virtual Stream to RAM 202 where it is available for further processing by CPU 203 or such other functional units as may be connected to the System Bus 207. Depending on the distribution of data and the encoding implemented by the Partial Stream Encoders 214 and 224 and decoded by the Partial Stream Integrator 205, the overall system can be targeted to perform a number of different optimizations and combinations thereof, including maximizing transmission bandwidth, assuring the security of data in transmission, and controlling the selectivity of programs to components of the overall virtual stream.

Practitioners skilled in the art will recognize that the overall system comprised by Local Computer System 200, Remote Computer System 210 and Remote Computer System 220 are functionally equivalent to the embodiment described in FIG. 1A except that the data sources in Storage Devices and associated Partial Stream Encoder functions are remotely located, communicating with the Partial Stream Integrator function over a network. Equally, such a skilled practitioner will understand that the inclusion of a single Storage Device 215 and associated Partial Stream Encoder 214 in Remote Computer System 210 and single Storage Device 225 and associated Partial Stream Encoder 224 in Remote Computer System 200 is merely for simplicity of representation and the architectural and implementation variants already described indicate that Remote Computer Systems 210 and 220 in this embodiment could equally include any practical number of desired storage devices and associated partial stream encoders and that all of them could generate partial streams which could be recombined by the single Partial Stream Integrator 204 on Local Computer System 200. Equally, the inclusion of Storage Device 205 or any other storage device without an associated partial stream encoder which might be added to Local Computer System 200 is not significant pertaining to the function of the invention since it does not generate partial streams, but is merely included to support the normal functioning of a generic computing system.

FIG. 1C shows a Local Computer System 300 communicating through Network Interface 301 through Network 350 with a Remote Computer System 320 through Network Interface 321 and with Remote Computer System 330 through Network Interface 331. A practitioner skilled in the art will understand that Local Computer System 300 is the same as Local Computer System 100 described in FIG. 1A and may be understood to include all the architectural and implementation variants described there and will also understand that Remote Computer Systems 320 and 330 described in FIG. 1B are the same as Remote Computer Systems 210 and 220 described in FIG. 1B and may be understood to include all the architectural and implementation variants described there so that the aggregate system described in this FIG. 1C combines the integration of local partial streams as described in FIG. 1A with the integration of remote partial streams as described in FIG. 1B and hence represents a system that is capable of servicing data requests from applications that mix heterogeneous sources of local and remote data such as, for one example among many, an interactive game application executing on a local computer utilizing data from a hard disk drive, and optical Compact Disc drive and from a remote multiplayer gaming server and a remote billing or administrative server on the Internet.

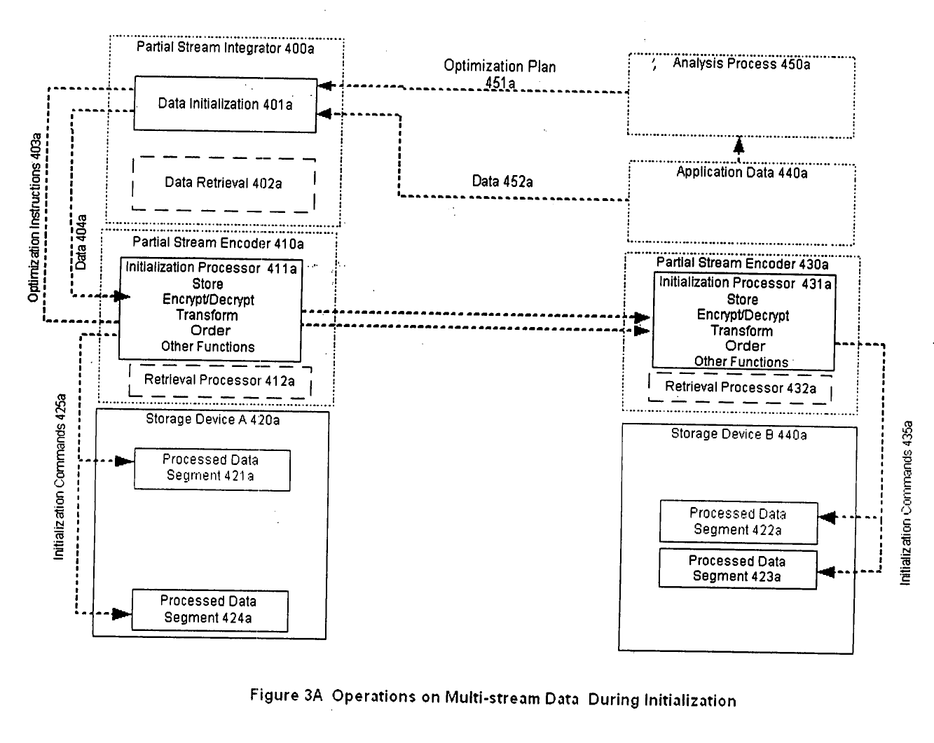

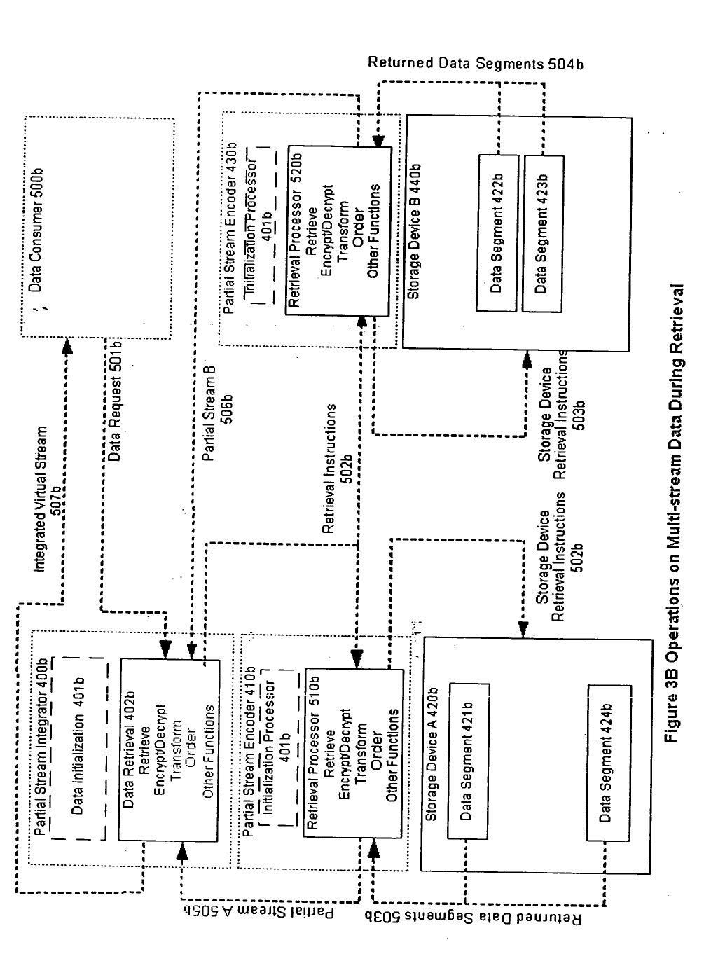

In this embodiment, a collection of associated data is stored on the Storage Device A 302 and Storage Device B 308 and Remote Storage Device C 325 and Remote Storage Device N 335 with the data either separated into component parts and distributed between said storage devices, or as duplicates stored on each of said storage devices. Upon a program request for said data, Partial Stream Encoder A 303 and Partial Stream Encoder B 307 and Partial Stream Encoder C 324 and Partial Stream Encoder N 335 select and encode a Partial Stream A 310 and a Partial Stream B 309 and Partial Stream C 326 and Partial Stream N 336 of data from the respective storage device with which they are associated, said partial streams consisting of either all of the component parts stored on said associated Storage Device if the data has been divided and distributed onto the storage devices, or a pre-arranged portion of duplicate data in the case that full duplicate data is stored on each Storage Device. Partial Streams A 310 and Partial Stream B 309 and Partial Streams C 326 and Partial Stream N 336 are communicated to Partial Stream Integrator 306 which restores full collection of data by combining said partial streams into an Integrated Virtual Stream 306 and communicates said Integrated Virtual Stream to RAM 305 where it is available for further processing by CPU 304 or such other functional units as may be connected to the System Bus 311 of the Local Computer System 300. Depending on the distribution of data and the encoding implemented by the Partial Stream Encoders 303, 307, 324 and 334 and decoded by the Partial Stream integrator 306, the overall system can be targeted to perform a number of different optimizations and combinations thereof, including, for example, maximizing transmission bandwidth, assuring the security of data in transmission, and controlling the selectivity of programs to components of the overall virtual stream. It will be understood by a practitioner skilled in the art that not only may the aggregate system be expanded so that an arbitrary number of local computer systems may request data from an arbitrary number of remote computer systems and integrate the transmitted partial remote streams, but that the configuration shown in FIG. 3C might also be reduced so that Local Computer System 300 included only one storage device and so that only one remote computer system was included, reducing the number of partial streams to a total of two.

FIG. 1D shows a block diagram illustrating an example of a local computer system 100d with only one storage device in accordance with the present invention. The local computer system 100d includes a System Bus 101d that couples together a CPU 103d, RAM memory 104d, and a single Storage Device 112 and further shows a Partial Stream Encoder 102d and a Partial Stream Integrator 105d according to this invention, whereby a collection of associated data is stored on the Storage Device 112. Upon a program request for said data, Partial Stream Encoder 102d selects segments of the data and encodes a Partial Stream A 108d and a Partial Stream N 109d of data from the storage device. Partial Stream A 108d and Partial Stream N 109d are communicated to Partial Stream Integrator 105d which restores full collection of data by combining said partial streams into an Integrated Virtual Stream 110d and communicates said Integrated Virtual Stream to RAM 104d where it is available for further processing by CPU 103d or such other functional units as may be connected to the System Bus 107a. Depending on the selection of data and the encoding implemented by the Partial Stream Encoders 112d and decoded by the Partial Stream Integrator 105d, the overall system can be targeted to perform a number of different optimizations and combinations thereof, including maximizing transmission bandwidth, assuring the security of data in transmission, and controlling the selectivity of programs to components of the overall virtual stream. This embodiment of the invention represents a special case where even though there is only one storage device and one partial stream encoder in the local computer system, the stored data is separated into multiple virtual partial streams and communicated to the partial stream integrator. To a practitioner skilled in the art it will be evident that such a selection of data segments and the processing of them into multiple virtual streams is possible. However, it will be less evident what the utility of so organizing said data may be since the multiple virtual partial streams cannot exploit any parallelism of storage devices and transmission channels and the multiple virtual partial streams must, in the end be transmitted serially through a single channel. However, this embodiment exploits the fact that, even with such constraints, there can be considerable practical utility to the selection of data and organizing it into multiple virtual partial streams. The skilled practitioner will understand such potential utility in relation to the following specific example which is representative of many possible cases. Digital photographs are typically stored in the JPEG file format and such files may be large and slow to retrieve from storage, particularly in photo-management applications where large numbers of files are retrieved in groups. In the typical file retrieval case where the file is treated as a homogeneous single stream of data, it may take a long time to retrieve a collection of complete files before any display of photos is possible. However, from analysis of the JPEG data we can know that a small miniaturized “thumbnail” representation of a photo is included in some JPEG files or that the DCT coding data of the file may be ordered to quickly generate such a thumbnail. If the file storage is organized such that a retrieval request for a number of files results in a Virtual Partial Stream of such thumbnails being transmitted separately a Virtual Partial Stream of the more voluminous data, it will result in the rapid transfer of immediately viewable replicas of the photos which may be usefully manipulated by the user in advance of the arrival of the full photo data.

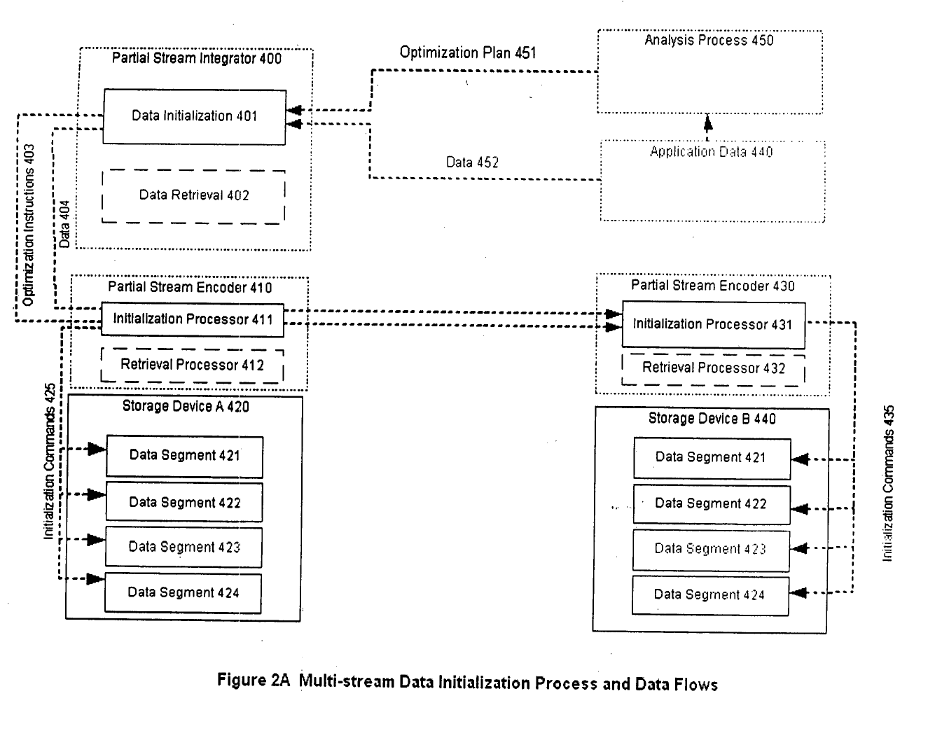

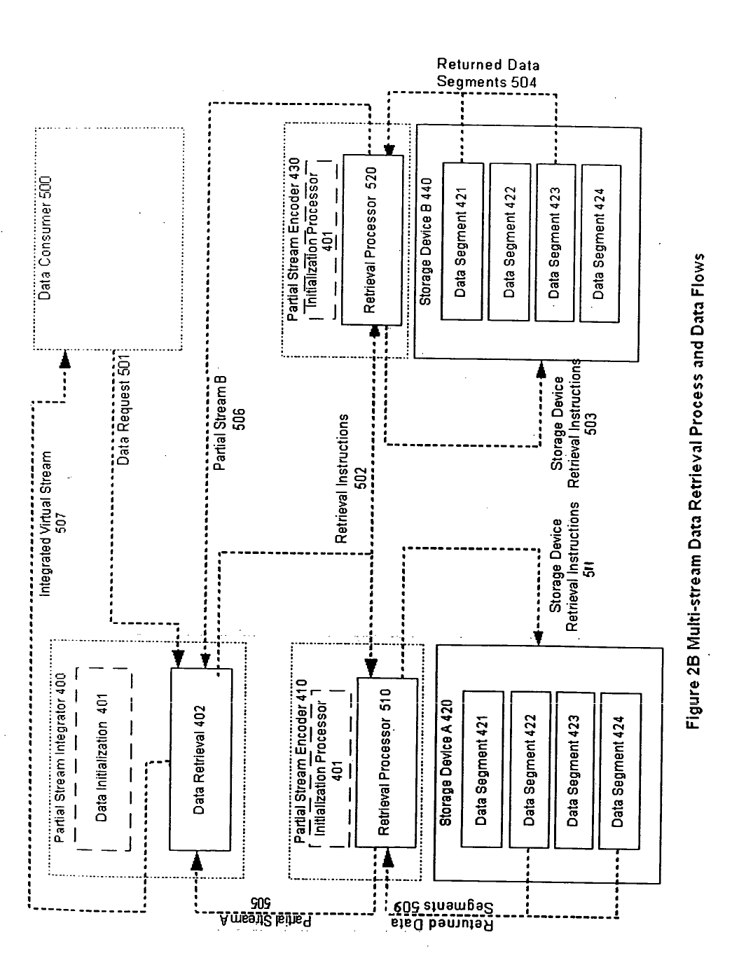

FIG. 2A shows a general block diagram of the data initialization process and data flows common to the embodiments described in relation to FIGS. 1A, 1B and 1C which is the initial phase of the method of the invention which is completed in a second data retrieval phase which is described in relation to FIG. 2B. As previously noted, the plurality of Partial Stream Encoders and the Partial Stream Integrator in each of the embodiments of the invention is typically implemented as a software process or processes running on the CPU of the local computer system or remote computer system as the case may be. However, it will be understood by a skilled practitioner that the partial stream encoder function or the partial stream integration function could equally be implemented as a software function running on a separate CPU coupled to the system bus of the local computer system or remote computer system and further, could be implemented in firmware, microcode or physical circuitry on said CPUs or even as custom hardware at various levels of integration from a co-processor board plugging into the bus of the respective computer systems to a custom integrated circuit integrated into the hosting computer system, or even integrated into the firmware or control circuitry of storage systems.

The initialization phase begins with an analysis process 450 by which the application data 440 for which optimized transmission is desired is analyzed, an optimization plan 451 is generated and data 452 to be stored is delivered to the Data Inititialization function 401 of the Partial Stream Integrator 400 (which is seen in the various described embodiments as 106, 204 and 306). The analysis process may be performed in a variety of ways; it may be automatically generated by instrumentation of an application to provide data concerning the associations of data in the running application, or it may be done by human analysis of the known datatypes of an application or by human analysis of a standard and well known datatype. It may equally be performed on a collection of associated files of an application or on a single file or data type. A practitioner skilled in the art will understand that the Optimization Plan 451 and the Data Initialization function 401 of the Partial Stream Integrator 400 may be implemented in a variety of ways, including, for example, as a set of instructions or parameters tQ control the functions of the Data Initialization function 401, or as metadata associated with the data itself in a self-describing data description language such as extensible Markup Language. The Data Initialization function 401 generates Optimization Instructions 403 and passes them along with Data 404 to the Initialization Processor 411 of the Partial Stream Encoder 410 and the Initialization Processor 431 of the Partial Stream Encoder 430 (which are seen in the various described embodiments as 102, 105, 214, 224, 303, 307, 324, and 334). The Initialization Processors 411 and 431 issue Initialization Commands 225 including data associated with the commands to their respective associated Storage Device 420 or 440, resulting in the storage of Data Segments 421, 422, 423, 424 on each storage device. As will be recalled from the descriptions of the various embodiments associated with FIGS. 1A, 1B and 1C, there are two basic variations of data initialization, replication where all of the data segments are duplicated between storage devices, and selective distribution where a portion of the data segments are stored on each storage device. The diagram of FIG. 2A shows replication initialization with Data Segments 421, 422, 423, 424 stored on each of Storage Device A 420 and Storage Device B 440. A different set of Optimization Instructions 403 could have resulted in Optimization Commands 425 and 435 that would result in any selection of Data Segments being uniquely stored on the respective Storage Devices, as long as the sum of the Data Segments stored on all Storage Devices could be recombined to create a reconstitution of the original data 452.

A practitioner skilled in the art will understand that the process and data flow shown in FIG. 2A is a general representation of many configurations that are envisioned in the embodiments described in relation to FIGS. 1A, 1B and 1C. Such a skilled practitioner will understand that the diagram and description, for clarity and simplicity of representation does not designate the physical computer boundaries of the processes and data flows described and understand that said processes and data flows actually may execute on multiple computing systems which may be distributed across a network. Also, such a skilled practitioner will understand that the Analysis Process 450 is potentially a real-time process which is tightly coupled to the Data Initialization function 401, but that in many cases it will be a separate process, performed at an earlier time from the Data Initialization 401, and the Optimization Plan 451 and Data 452 will be loaded into the Data Initialization function 401 at a later time. For clarity on this point, an example might involve the design of an code and some data, along with an optimization plan created in the development process of the game, are distributed on a Compact Disc optical medium. On installation of the application, using a CD drive on the end user's local computer system, which might be a personal computer or a gaming console, the optimization plan would be loaded into the data initialization function and part of the data moved to the local computer system's hard disk drive. The developer of this hypothetical exemplary application also stored a portion of the application data on a storage system on a server on the Internet and this data is also referenced by the optimization plan. In playing of the this hypothetical game, a user action may request data which is actually stored in three separate storage devices with substantially different retrieval characteristics, a low-latency, fast-seek, high data-rate, medium-capacity hard drive, a high-latency, slow-seek, medium data-rate, low-capacity CD drive, and a very high-latency, high-seek, medium data-rate, extremely high-capacity network server. The role of the analysis process is to decide on the optimal division of the overall data components to exploit the characteristics of the different storage devices and retrieval characteristics to achieve the best user experience or system efficiency or security or other design goal as the case may be. A skilled practitioner will recognize that many different configurations of heterogeneous storage devices will exist and that the essence of the current invention is to manage the optimization of such variable and complex storage configurations. Finally, a skilled practitioner will understand that the embodiment of the invention described in relation to FIG. 1D is a converse boundary case of such possible configurations, where the system is reduced to a single storage device and partial stream encoder and where multiple virtual partial streams are multiplexed over a single channel and moreover that such a case of multiplexed virtual partial streams can be included in any of the more complex heterogeneous systems envisaged in the other embodiments which have been described.

FIG. 2B shows a general block diagram of the data retrieval and integration process and data flows common to the embodiments described in relation to FIGS. 1A, 1B and 1C which is the second phase of the method of the invention which is started in a first initialization phase which is described in relation to FIG. 2A. In FIG. 2B a Data Consumer 500, which will typically be a program function activated by end user interaction with an application running on a local computer system, generates a Data Request 501 to the Data Retrieval function of the Partial Stream Integrator 400 (which is seen in the various described embodiments as 106, 204 and 306), which passes Retrieval Instructions 502 to Retrieval Processors 510 and 520 of the Partial Stream Encoders 410 and 430 (which is seen in the various described embodiments as 102, 105, 214, 224, 303, 307, 324, and 334). The said Retrieval Processors 510 and 520 generate Storage Device Retrieval Instructions 502 and 503 to Storage Device A 420 and Storage Device B 440 respectively. As will be recalled from the descriptions of the various embodiments associated with FIGS. 1A, 1B and 1C, there are two basic variations of data initialization, replication where all of the data segments are duplicated between storage devices, and selective distribution where a portion of the data segments are stored on each storage device. The diagram of FIG. 2A shows replication initialization with Data Segments 421, 422, 423, 424 stored on each of Storage Device A 420 and Storage Device B 440. A different set of Optimization Instructions 403 could have resulted in Optimization Commands 425 and 435 that would result in any selection of Data Segments being uniquely stored on the respective Storage De-vices, as long as the sum of the Data Segments stored on all Storage Devices could be recombined to create a reconstitution of the original data 452. Therefore in the current representation, where all of the data segments have been stored on each of the storage devices in the initialization phase, the retrieval phase is creating a partial stream by selecting a portion of the data from each storage device as directed by the data retrieval instructions 502 and the Storage Device retrieval instructions 502, in this case Data Segments 422 and 424 from Storage Device 420 and Data Segments 421 and 423 from Storage Device 440 and these Returned Data Segments 503 and 504 are returned to Retrieval Processors 510 and 520 respectively, where, after any processing designated in the Retrieval Instructions 502 and 503, they are passed as Partial Stream A 505 and Partial Stream B 506 to the Data Retrieval function 402 of the Partial Stream Integrator 400 and finally returned as a re-constructed Integrated Virtual Stream 507 to the Data Consumer 500 in satisfaction of the original Data Request 501.

A practitioner skilled in the art will recognize that FIG. 2B is an extension of the description associated with FIG. 2A and subject to the same variations and implementation options there described including the option of multiplexed virtual partial streams as described in relation to FIG. 1D. As well such a skilled practitioner will recognize that the specific number of data segments described in FIGS. 2A and 2B is a representative example and that the actual number of data segments is a variable which is determined by the data analysis process and the size of the data stored in the system.

FIG. 3A and FIG. 3B show an enhanced variant of the method described in FIGS. 2A and 2B. As previously noted in FIG. 1A, 1B, 1C and 1D, depending on the distribution of data and the encoding implemented by the Partial Stream Encoders and decoded by the Partial Stream Integrator, the overall system can be targeted to perform a number of different optimizations and combinations thereof, including maximizing transmission bandwidth, assuring the security of data in transmission, and controlling the selectivity of programs to components of the overall virtual stream. To achieve the full range of stated benefits, the invention provides that as well as effecting selective storage and retrieval of the data segments on specific storage devices, the Partial Stream Encoders may include functions that act to modify the form of the data as it is either stored or retrieved from storage, the only constraint being that the function that transforms the data must be capable of reversing the transformation to the extent that the data may still be processed by the application that delivers the data for storage and makes requests to consume data. This constraint does not imply that the reverse transformation function must restore a completely identical replica of the original data. In many practical applications lossy transformations are in fact advantageous as will be seen in the discussion of specific examples below.

FIG. 3A shows the initialization phase of the enhanced variant of the method, in which Analysis Process 450a communicates an Optimization Plan 451a that includes instructions for transforming certain elements of Data 452a to Data Initialization function 401a of Partial Stream Integrator 400a which communicates Optimization Instructions 403a to Initialization Processor 411a and 431a respectively of Partial Stream Encoders 410a and 430a. Said Initialization Processors include functions to process select portions of the data in response to Optimization Instructions 403a. For exemplary purposes, the Initialization Processors in FIG. 3A include functions to store, encrypt or decrypt, transform, encode, order, or otherwise act upon the designated data. Once the designated function has been performed, the Store function is invoked through Initialization Commands 425a and 435a to the Storage Device A 420a and Storage Device 440a respectively, resulting in the storage of Processed Data Segment 421a and Processed Data Segment 424a being stored on Storage Device A 420a and Processed Data Segments 422a and 423a being stored on Storage Device B 440a.

It will be evident to a skilled practitioner that imposition of any such arbitrary function on the selected data is possible, but the utility of so doing may not be immediately evident. To clarify the utility of the general case we can consider a specific example where the function is to perform the Encrypt function to create Processed Data Segments 422a and 423a which we will assume are small components of the overall data without which the overall data is incomprehensible, and to perform an entropy encoding compression function to create Processed Data Segments 421a and 424a which are large relative to the encrypted segments but which can tolerate data loss without seriously affecting the comprehension of the overall data. Let us assume that Storage Device A 420a with the large compressed data communicates over a fast, but noisy channel and Storage Device B communicates over a slower channel. The net result of distributing the data and processing it as designated will be to allow satisfactory secure transmission of the total signal with little total encryption overhead and little adverse effect of the noisy channel which in other circumstances would have blocked the whole signal by disrupting the encryption which is sensitive to data loss and incurred a very large encryption overhead by forcing encryption of the entire data. A skilled practitioner will understand from this example that selecting the size of data subsets to be processed and the processing function to be applied to the respective subsets of the total data so as to create partial streams that are matched to the characteristics of the channels through which they are transmitted provides great flexibility in optimizing the overall data transmission.

FIG. 3B shows the retrieval phase of the enhanced variant of the method, in which the transformations that are imposed on the selected data are reversed and the data returned to a form that can be processed by the application which consumes the data. The Data Consumer 500b makes a data request to the Data Retrieval function 402b of the Partial Stream Integrator 400b which passes Retrieval Instructions 502b to the retrieval Processors 510b and 520b of the Partial Stream Encoder 410b and 430b respectively, which pass Storage Retrieval Instructions 502b and 503b to Storage Devices 420b and 440b resulting in the retrieval of Processed Data Segments 421b and 424b from Storage Device A 420b to Retrieval Processor 510b and Processed Data Segments 422b and 423b from Storage Device B 440b to Retrieval Processor 520b. At this point, a choice is made dependent on the nature of the Retrieval Instructions 502b. The Retrieval Processors will either pass the data on unchanged as Partial Stream A 505b and Partial Stream B 502b, or may execute a function that further transforms the data or restores it to an earlier form. In either case, the partial streams are communicated to the Data Retrieval function 402b of the Partial Stream Integrator 400b where they are subjected to functions that restore the data to a form which can be processed by the Data Consumer 500b and combine the partial streams into an Integrated Virtual Stream 507b which is communicated to the Data Consumer 500b. This completes the cycle which commenced with data initialization in FIG. 3A.

For greater clarity in understanding the generality of the methods described in relation to FIGS. 3A and 3B above, further specific embodiments are described. For instance, we consider the case of an interactive game application which stores texture data for its three dimensional models in files. Analysis of the retrieval patterns of the application indicates that the file headers are time-critical and must be delivered completely intact to set up the parameters of multiple models, and the texture data is very large compared to the header information. Such structures are problematical for the application because, in setting up multiple models, single channel transmission makes each model wait for its header set-up information until all of the very large texture data from the previous model has been transferred. This invention provides several options for optimizing the transfer of such a data structure. First, on initialization, the initialization processors could separate the data so that data segments relating to headers was stored in a separate storage device from texture data so that on retrieval a partial stream of multiple headers could be retrieved very rapidly to initialize multiple models rapidly. Second, the texture data could be transformed in the retrieval processor so that it could be progressively rendered. This is an example of combining an order function in the retrieval processor with a transform function. The transformation of data for progressive rendering allows the order to be altered to transfer less detailed textures for all models first and then progressively greater detail over time, avoiding any perceptual gaps or halts in game play that might occur in the case where multiple models have to wait for the full completion of texture transfer in another model. The importance of multiple partial streams based on ordering and transformation is most evident in the boundary case where there is only one storage device in the system and one physical channel. For example, consider the case of transferring JPEG digital photo data from a camera to a personal computer for review and editing using a flash memory card carrying the camera JPEG data as the transfer medium. Plugging the flash memory card into a reader connected to the PC, the transfer conventionally precedes with a image-by-image transfer of the JPEG data resulting in a considerable wait before any review of all the photos is possible. However, following the teaching of this invention, it is possible to analyze the JPEG data structure into two partial streams, a thumbnail stream based on a selection of the Discrete Cosine Transfer coefficients that constructs a small representative “thumbnail” version of all the photos, and a progressive rendering stream version of the larger full data allows a much more satisfying user experience. Ordering the two streams through the single channel so that the thumbnail stream is delivered first allows the user to review immediately and unimpeded all of the photos, probably before even a single complete image transfer would have occurred in the single stream case. A skilled practitioner will understand that most datastructures can be optimized in a similar fashion, since once the application that consumes the data is known, it is possible to evaluate the consequences of particular data division, processing and ordering relative to the characteristics of available transmission channels and processing resources. In considering the general case, specific well-known datastructures are helpful. For instance, the very common MPEG 2 encoding format offers several evident natural data division opportunities. For example, it is easy to conceive of multiple streams that separate the intra-frame MPEG data from the inter-frame MPEG data, or, along another dimension, separate the MPEG Discrete Cosine Transfer Coefficients from the residual stripped video data. Alternatively, one might consider the datastructure associated with well-known wavelet compression techniques, where it is possible to separate the data into multiple parallel streams, each representing signal elements of a different spatial frequency. Each of these partial stream strategies would present different optimization potential depending on other factors such as the nature of the application and the supporting system configuration. Indeed, it is equally clear that treating data structures as a single unit can have side-effects that introduce sub-optimal results. For example, in interactive video games it has often been the practice to compress datastructures to conserve disk space. However, the perspective of this teaching explains the negative side-effects that sometimes ensue, since the process of compressing large datastructures is a transformation that makes all of the datastructure interdependent so that retrieval of a part is no longer possible, giving the application designer the negative consequence of being able to store more data, but being unable to retrieve small parts without major retrieval delays.

A skilled practitioner will understand that the description of specific examples and applications is designed to illuminate the variability and breadth of the invention and that many specific embodiments could be constructed by any skilled practitioner by combining permutations and combinations of the systems and methods described and is not intended to limit the invention to any of the exemplary descriptions.

While the particular embodiments of systems and methods for optimizing data transmission using virtual streaming by dividing the data into a plurality of parts as herein shown and described in detail are fully capable of attaining the above-described objects of the invention, it is to be understood that they are the presently preferred embodiments of the present invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. .sctn.112, sixth paragraph, unless the element is expressly recited using the phrase “means for” or, in the case of a method claim, the element is recited as a “step” instead of an “act”.

1. A system for optimizing data transmission using virtual streaming by dividing the data into a plurality of parts, storing the parts on various components of the system, optionally processing or transforming each part in a fashion that matches it to the optimal characteristics of the channel or channels connected to the component, before transmitting the parts through multiple channels as partial streams, each representing a part of an overall virtual stream, then re-assembling the partial streams for further processing or presenting the media to the end user, the system including:
a local computer system, which further includes, two or more storage devices, a central processing unit (“CPU”), random access memory (“RAM”), a system bus or other means of transmitting data between the functional components of the system, and, functions to store components of a single data structure separately on the storage devices, to retrieve said components and to encode them as multiple partial streams, to transmit the partial streams to a function that re-integrates them into a single virtual stream, to transmit the single virtual stream to RAM where the data is stored for rapid access by the CPU.

2. A system for optimizing data transmission using virtual streaming by dividing the data into a plurality of parts, storing the parts on various components of the system, optionally processing or transforming each part in a fashion that matches it to the optimal characteristics of the channel or channels connected to the component, before transmitting the parts through multiple channels as partial streams, each representing a part of an overall virtual stream, then re-assembling the partial streams for further processing or presenting the media to the end user, the system including:
a network, one or more remote computer systems, which further include, a network interface, one or more storage devices, a central processing unit (“CPU”), random access memory (“RAM”), a system bus or other means of transmitting data between the functional components of the system, and, functions to store components of a single data structure separately on the storage devices, to retrieve said components and to encode them as multiple partial streams and to transmit the partial streams over the network to a local computer system;
a local computer system, which further includes, a network interface, one or more storage devices, a central processing unit (“CPU”), random access memory (“RAM”), a system bus or other means of transmitting data between the functional components of the system, and, functions to receive said multiple partial streams from remote computers over a network, to re-integrate them into a single virtual stream, to transmit the single virtual stream to RAM where the data is stored for rapid access by the CPU.

3. A system for optimizing data transmission using virtual streaming by dividing the data into a plurality of parts, storing the parts on various components of the system, optionally processing or transforming each part in a fashion that matches it to the optimal characteristics of the channel or channels connected to the component, before transmitting the parts through multiple channels as partial streams, each representing a part of an overall virtual stream, then re-assembling the partial streams for further processing or presenting the media to the end user, the system including:
a network, one or more remote computer systems, which further include, a network interface, one or more storage devices, a central processing unit (“CPU”), random access memory (“RAM”), a system bus or other means of transmitting data between the functional components of the system, and, functions to store components of a single data structure separately on the storage devices, to retrieve said components and to encode them as multiple partial streams and to transmit the partial streams over the network to a local computer system; a local computer system, which further includes, a network interface two or more storage devices, a central processing unit (“CPU”), random access memory (“RAM”), a system bus or other means of transmitting data between the functional components of the system, and, functions to store components of a single data structure separately on said storage devices, to retrieve said components from the local storage devices and to encode them as multiple partial streams, and to receive multiple partial streams from remote computers over the network, to transmit the local and remote partial streams to a function that re-integrates them into a single virtual stream, to transmit the single virtual stream to RAM where the data is stored for rapid access by the CPU.

4. A system for optimizing data transmission using virtual streaming by dividing the data into a plurality of parts, storing the parts on various components of the system, optionally processing or transforming each part in a fashion that matches it to the optimal characteristics of the channel or channels connected to the component, before transmitting the parts through multiple channels as partial streams, each representing a part of an overall virtual stream, then re-assembling the partial streams for further processing or presenting the media to the end user, the system including:
a local or remote computer system, which further includes, one or more storage device, a central processing unit (“CPU”), random access memory (“RAM”), a system bus or other means of transmitting data between the functional components of the system, and, functions to store components of a single data structure separately on a single storage device, to retrieve said components, order them in a particular order and to encode them as multiple partial streams, to transmit the partial streams sequentially through a single channel to a function that re-integrates them into a single virtual stream, to transmit the single virtual stream to RAM where the data is stored for rapid access by the CPU.

5. The system of claims 1 to 4 where other functional hardware units are coupled to the system bus or other means of transmitting data between the functional components of the system or other software functions are provided in addition to the functions described in the invention.

6. A storage system that is a sub-system of a host computer system or a stand-alone storage system such as a Network Attached Storage system or Storage Area Network system or Storage Appliance which is sold to end-users or OEM equipment manufacturers or distributed through a distribution system which includes the components and functions of a remote computer or local computer in claims 1 to 5.

7. A remote computer as described in claims 2 to 6 which is sold to end-users or distributed through a distribution system.

8. The systems of claims 2 to 5 where the network is a wide-area or global network such as the internet.

9. The system of claims 2 to 5 where the network is a local area network in a business office or home or other setting.

10. The system of claims 2 to 5 where the network is a wireless network such as IEEE 802.11a, b, g or other variant, Bluetooth, any cellular telephony variant that carries digital data, ultra-wideband wireless network, or any other wireless network.

11. The system of claims 1 to 10 where the data structures for transmission are derived from one or more types of software, including computer application software, games, operating software, utilities, updates, expansion paks, plug-ins, application data, scripts, music, still photographs, film, audio, video, or multi-media, interactive models, databases, or any other executable or source code or data.

12. The system of claims 1 to 11 where the storage device is one or more of any recordable storage device type such as magnetic storage devices such as hard disk drives and floppy disk drives and magnetic tape drives, or optical storage devices such as recordable compact disc drives, or recordable DVD drives, or holographic memory, or semiconductor mass memory devices, or any other mass memory device, or any non-recordable storage device type such as optical storage devices such as compact disc drives, or DVD drives, or fixed holographic memory, or read-only semiconductor mass memory devices, or any other non-recordable mass memory device, or any non-recordable storage device.

13. The system of claims 1 to 12 where the storage device integrates with a computer or storage system through one or more means such as an internal system coupled through the system bus, an internal or external system coupled through a cable and connector and a protocol such as USB, Firewire, RAID, Fibrechannel, Infiniband or any other form of coupling.

14. A method of optimizing data transmission using virtual streaming, whereby, an application is identified which processes a particular data structure which must be transmitted from persistent storage on a storage device to RAM which is closely coupled to the CPU on a local computer executing the application, the performance requirements and limitations of the application relative to said datastructure are analyzed, the types of storage devices and the characteristics of the transmission channels between the storage devices and said RAM are analysed, said data structure is subjected to a process of analysis to reveal how it may be separated into component parts, the characteristics of said component parts are analyzed relative to the characteristics of said available storage devices and transmission channels, an optimum match of said component parts to specific storage devices and associated transmission channels is decided based on the performance requirements of the application, in operation of the application, said component parts are stored on the specific storage devices with associated transmission channels that provides said optimum match with the performance requirements of the application, a retrieval request function is provided on the local computer that, on request for retrieval of an instance of the data structure from the application, redirects the request to the specific storage devices that stores said component parts, an encoder function is provided relative to each storage device that, on request for retrieval of an instance of the data structure from the retrieval request function, retrieves and encodes the component part data stored on the associated storage device and transmits it through the associated channel as a partial stream to an integration function, the multiple partial streams are re-assembled into a form of the original datastructure that can be stored in RAM and processed by the application.

15. A method of optimizing data transmission using virtual streaming, whereby, an application is identified which processes a particular data structure which must be transmitted from persistent storage on one or more storage devices on two or more remote computers through a network to RAM which is closely coupled to the CPU on a local computer executing the application, the performance requirements and limitations of the application relative to said datastructure are analyzed, the computational capabilities of the remote computers, the types of storage devices and the characteristics of the transmission channels through the network between the remote computers and said RAM on the local computer are analysed, said data structure is subjected to a process of analysis to reveal how it may be separated into component parts, the characteristics of said component parts are analyzed relative to the characteristics of said remote computers, available storage devices and network transmission channels, an optimum match of said component parts to specific remote computers, storage devices and associated network transmission channels is decided based on the performance requirements of the application, in operation of the application, said component parts are stored on the specific storage devices with associated network transmission channels on remote computers that provides said optimum match with the performance requirements of the application, a retrieval request function is provided on the local computer that, on request for retrieval of an instance of the data structure by the application, redirects the request through the network to the specific remote computers and storage devices that store said component parts, an encoder function is provided relative to each storage device that, on request for retrieval of an instance of the data structure from the retrieval request function, retrieves and encodes the component part data stored on the storage device and transmits it through the associated channel over the network as a partial stream to an integration function on the local computer, the multiple partial streams are re-assembled into a form of the original datastructure that can be stored in RAM and processed by the application through the CPU of the local computer.

16. A method of optimizing data transmission using virtual streaming, whereby, an application is identified which processes a particular data structure which must be transmitted from persistent storage on one or more storage devices on a local computer and on one or more storage devices on one or more remote computers through a network, to RAM which is closely coupled to the CPU on a local computer executing the application, the performance requirements and limitations of the application relative to said datastructure are analyzed, the computational capabilities of the local and remote computers, the types of storage devices and the characteristics of the transmission channels through the network between the remote computers and said RAM on the local computer are analysed, said data structure is subjected to a process of analysis to reveal how it may be separated into component parts, the characteristics of said component parts are analyzed relative to the characteristics of said local and remote computers, available storage devices and network transmission channels, an optimum match of said component parts to specific local and remote computers, storage devices and associated local and network transmission channels is decided based on the performance requirements of the application, in operation of the application, said component parts are stored on the specific storage devices with associated local or network transmission channels on, local or remote computers that provide said optimum match with the performance requirements of the application, a retrieval request function is provided on the local computer that, on request for retrieval of an instance of the data structure by the application, redirects the request to local storage devices through a local transmission channel and through the network to the specific remote computers and storage devices that store said component parts, an encoder function is provided relative to each storage device that, on request for retrieval of an instance of the data structure from the retrieval request function, retrieves and encodes the component part data stored on the storage device and transmits it through the associated channel locally or over the network as a partial stream to an integration function on the local computer, the multiple partial streams are re-assembled into a form of the original datastructure that can be stored in RAM and processed by the application through the CPU of the local computer.

17. A method of optimizing data transmission using virtual streaming, whereby, an application is identified which processes a particular data structure which must be transmitted from persistent storage on a storage device to RAM which is closely coupled to the CPU on a local computer executing the application, the performance requirements and limitations of the application relative to said datastructure are analyzed, the characteristics of a particular single storage devices and associated transmission channels between the storage device and said RAM are analyzed, said data structure is subjected to a process of analysis to reveal how it may be separated into component parts, an optimum ordering of said component parts is decided based on the performance requirements of the application, in operation of the application, said component parts are stored on the specific single storage device with associated transmission channel, a retrieval request function is provided on the local computer that, on request for retrieval of an instance of the data structure from the application, redirects the request to the specific single storage device that stores said component parts, an encoder function is provided relative to each storage device that, on request for retrieval of an instance of the data structure from the retrieval request function, retrieves and encodes the component part data stored on the associated storage device and transmits it through the associated channel as a stream in the said pre-determined optimal ordering to RAM, the component parts are processed by the application, taking advantage of the early availability of the components first received.

18. The method of claims 14 to 16 where the method of claim 17 is applied to the storage and retrieval of one or more of the component parts of the datastructure.

19. The method of claims 14 to 16 where all of the component parts of the datastructure are stored on each of the storage devices and partial streams are created on retrieval by selecting a sub-set of components and encoding them into a partial stream.

20. The method of claims 14 to 16 where a sub-sets of components are selected in advance of storage and different sub-sets of components are stored on different storage devices.

21. The method of claims 19 and 20 where all of the component parts of the datastructure are stored on some storage devices and sub-sets of components selected in advance are stored on other storage devices.

22. The method of claims 14 to 21 where the function of analyzing the application performance requirements, or the data structure possible components, or the local or remote computer capabilities, or the device characteristics, or the transmission channel characteristics, or the assignment of data components to specific storage devices, or any combination of them, is performed by a human analyst.

23. The method of claims 14 to 21 where the function of analyzing the application performance requirements, or the data structure possible components, or the local or remote computer capabilities, or the device characteristics, or the transmission channel characteristics, or the assignment of data components to specific storage devices, or any combination of them, is performed by an automated software function.

24. The method of claim 23 where the automated analysis is performed in advance of the execution of the application and subsequently applied to executions of the program.

25. The method of claim 23 where the automated analysis is performed and applied dynamically during the execution of the program.

26. The method of claim 23 where the automated analysis is performed in advance of the execution of the program and subsequently applied to executions of the program and dynamically updated by a dynamic analysis performed during the execution of the program.

27. The method of claim 22 and 23 where the expression of the analysis is a set of instructions activating the functions of the invention with a separate stream of data which the instructions are designed to act upon.

28. The method of claim 22 and 23 where the expression of the analysis is a set of mixed data and instructions.

29. The method of claim 22 and 23 where the data and/or the instructions to act on the data are expressed in a self-describing data format such as extensible Markup Language.

30. The method of claims 14 to 23 where optimization is organized to provide maximum data transmission speed.

31. The method of claims 14 to 23 where the optimization is organized to provide data security.

32. The method of claims 14 to 23 where the optimization is organized to provide differential selectivity of data within different components of the datastructure.

33. The method of claims 14 to 23 where the optimization is organized to provide differential performance for different functions of the application.

34. The method of claims 14 to 29 where the multiple optimizations are provided for the same datastructure.

35. The method of claims 14 to 34 where arbitrary processing functions may be applied to the components of the datastructure in the process of distribution through a channel and/or storage on a specific storage device and in the retrieval and/or transmission through a channel, and/or the recombination of partial streams as long as the combination of functions allows the reconstitution of the datastructure to a form that may be processed by the application that requests the datastructure.

36. The method of claim 35 where the processing functions include encryption and/or decryption of one or more components and/or partial streams.

37. The method of claim 35 where the processing functions include re-ordering of the data of one or more components and/or partial streams.

38. The method of claim 35 where the processing functions include transformation and/or inverse transformation of the data of one or more components and/or partial streams.

39. The method of claim 35 where the processing functions include compression and/or decompression of the data of one or more components and/or partial streams.

40. The method of claim 35 where any processing function may be executed remotely on another remote computer or local computer according to a remote procedure call or other distributed processing or grid computing architecture.

41. A method of manufacture of a local computer or a remote computer as described in claims 1 to 5 whereby the software functions are pre-installed in the process of assembly and testing.

42. A method of manufacture of a local computer or a remote computer as described in claims 1 to 5 whereby the software functions are pre-installed after assembly and testing in the process of distribution in advance of sale to the end-user.

43. A method of manufacture of a local computer or a remote computer as described in claims 1 to 5 whereby the some or all of the functions described are provided by reduction to custom hardware components or sub-systems such as a co-processor board plugging into the bus of the respective computer systems, or a custom integrated circuit integrated into the local or remote computer, or as firmware, microcode or physical circuitry on CPU of the local or remote computer.

44. A method of manufacture of a storage system as described in claim 6 whereby the software functions are pre-installed in the process of assembly and testing.

45. A method of manufacture of a storage system as described in claim 6 whereby the software functions are pre-installed after assembly and testing in the process of distribution in advance of sale to the end-user.

46. A method of manufacture of a storage system as described in claims 6 whereby the some or all of the functions described are provided by reduction to custom hardware components or sub-systems such as a co-processor board plugging into the bus of the respective computer systems, or a custom integrated circuit integrated into the local or remote computer, or as firmware, microcode or physical circuitry on a CPU or control processor of the storage system.

47. A method of manufacture of storage device as described in claims 1 to 6 whereby the functions that are isolated to operations that may be performed on a single storage device are provided by reduction to custom hardware components or sub-systems such as a co-processor board or respective or a custom integrated circuit integrated into the storage device, or as firmware, microcode or physical circuitry on CPU or control processor of the storage device.

48. A computer-readable medium having stored thereon a computer software for use on a local computer for optimizing data transmission using virtual streaming by dividing the data into a plurality of parts, storing the parts on various storage devices of the local computer, transmitting the parts through multiple channels as partial streams, each representing a part of an overall virtual stream, then re-assembling the partial streams for further processing or presenting the data to the end user.

49. A computer-readable medium having stored thereon a computer software for use on a remote computer for optimizing data transmission using virtual streaming by dividing the data into a plurality of parts, storing the parts on various storage devices of the remote computer, before transmitting the parts through multiple channels as partial streams, each representing a part of an overall virtual stream, to a local computer.

50. A computer-readable medium having stored thereon a computer software for use on a local or remote computer for optimizing data transmission using virtual streaming by dividing the data into a plurality of parts, storing the parts on a single storage device remote computer, ordering the parts for optimal utility in an application, before transmitting the parts through a channel to RAM that is closely coupled to the CPU of a local computer which is executing the application.

51. The computer-readable medium of claim 48 having stored thereon software modules that process or transform any part of the data in a fashion that matches it to the optimal characteristics of a storage device and the channel or channels connected to the storage device.

52. The computer-readable medium of claim 49 having stored thereon software modules that process or transform any part of the data in a fashion that matches it to the optimal characteristics of a storage device and the channel or channels connected to the storage device or/and to the network connecting the remote computer to the local computer.

53. The computer-readable medium of claim 50 having stored thereon software modules that process or transform or re-order any part of the data in a fashion that matches it to the optimal characteristics of a storage device and the channel or channels connected to the storage device.

54. A computer-readable medium having stored thereon a computer software for use on a storage system as described in claim 6 for optimizing data transmission using virtual streaming by dividing the data into a plurality of parts, storing the parts on various storage devices of the storage system, before transmitting the parts through multiple channels as partial streams, each representing a part of an overall virtual stream.

54. The computer-readable medium of claim 54 having stored thereon software modules that process or transform or re-order any part of the data in a fashion that matches it to the optimal characteristics of a storage device and the channel or channels connected to the storage device.
